(19) United States
(12) Patent Application Publication
(10) Pub. No.: US 2024/0163700 A1
(43) Pub. Date: May 16, 2024

(54) DEVICE FOR OPERATING A RADIO COMMUNICATION NETWORK, TERMINAL COMMUNICATION DEVICE, AND METHOD FOR OPERATING A RADIO COMMUNICATION NETWORK

(71) Applicant: Intel Corporation, Santa Clara, CA (US)

(72) Inventors: Anshu AGARWAL, Bangalore (IN); Krishna Chaitanya SUDI, Bellandur (IN); Mythili HEGDE, Bangalore (IN); Ingolf KARLS, Feldkirchen (DE)

(21) Appl. No.: 17/985,971

(22) Filed: Nov. 14, 2022

(51) Int. Cl. H04W 24/08; H04W 24/10

(52) U.S. Cl. CPC H04W 24/08; H04W 24/10

(57) ABSTRACT

A device for operating a radio communication network may include a processor configured to receive radio communication network operational data from at least one communication terminal in accordance with a communication device management protocol, and determine communication network operation parameters to control the operation of the communication network based on the received radio communication network operational data, and may include a memory to store the radio communication network operational data.

### TECHNICAL FIELD

Various aspects of this disclosure generally relate to devices and methods for operating and configuring a radio communication network and terminal communication devices. By way of example, various aspects relate to devices and methods for operating a radio communication network receiving radio communication network operational data from at least one communication terminal device and using a communication device management protocol.

### BACKGROUND

Mobile network operators are currently faced with commercial and technical pressures to continuously enhance their services in terms of user experience, efficiency and performance.

Data analytics offers a plethora of opportunities to mobile network operators for improving quality of service & network performance. Mobile network operators nowadays collect ample data about where, when and how subscribers of their services use their devices and establish usage patterns. Data Analytics is a key enabler even for 5G cellular networks and can be applied to improve the performance of several mechanisms, ranging from the supervision of Internet of Things, IoT, terminals to network management, to improving network performance.

As per 3GPP TR 23.791, some issues regarding collecting UE information to improve network efficiency are currently investigated.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. It should be understood that the drawings are diagrammatic and schematic representations of exemplary aspects of the invention, and are neither limitative nor necessarily drawn to scale of the present invention. In the following description, various embodiments of the invention are described with reference to the following drawings, in which:

FIG. 1 shows an exemplary communication network;

FIG. 2 shows another exemplary communication network according to some aspects;

FIG. 3 shows an exemplary LwM2M server and client according to some aspects;

FIG. 4 shows an exemplary framework of a LwM2M server in 5GC;

FIG. 5 shows an exemplary implementation of a LwM2M server including a direct data collection client according to some aspects;

FIG. 6 shows an exemplary implementation of a LwM2M server including an indirect data collection client according to some aspects;

FIG. 7 shows exemplary interactions between the NWDAF and 5GC network functions using a LwM2M server data for data collection;

FIG. 8 shows the protection of LwM2M communication using the OSCORE security protocol;

FIG. 9 shows an exemplary device for operating a radio communication network according to some aspects;

FIG. 10 shows an exemplary terminal communication device according to some aspects; and

FIG. 11 shows a flowchart illustrating a method for operating a device according to some aspects;

### DESCRIPTION

The following detailed description refers to the accompanying drawings that show, by way of illustration, specific details and embodiments in which the invention may be practiced.

The word “exemplary” is used herein to mean “serving as an example, instance, or illustration”. Any embodiment or design described herein as “exemplary” is not necessarily to be construed as preferred or advantageous over other embodiments or designs.

The terms “at least one” and “one or more” may be understood to include a numerical quantity greater than or equal to one (e.g., one, two, three, four, [ . . . ], etc.). The term “a plurality” may be understood to include a numerical quantity greater than or equal to two (e.g., two, three, four, five, [ . . . ], etc.).

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. The phrases “group (of)”, “set (of)”, “collection (of)”, “series (of)”, “sequence (of)”, “grouping (of)”, etc., and the like in the description and in the claims, if any, refer to a quantity equal to or greater than one, i.e., one or more. The phrases “proper subset”, “reduced subset”, and “lesser subset” refer to a subset of a set that is not equal to the set, illustratively, referring to a subset of a set that contains less elements than the set.

The phrase “at least one of” with regard to a group of elements may be used herein to mean at least one element from the group including the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and represent any information as understood in the art.

The terms “processor” or “controller” as, for example, used herein may be understood as any kind of technological entity that allows handling of data. The data may be handled according to one or more specific functions executed by the processor or controller. Further, a processor or controller as used herein may be understood as any kind of circuit, e.g., any kind of analog or digital circuit, and may also be referred to as a “processing circuit,” “processing circuitry,” among others. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality, among others, and conversely that any single processor, controller, or logic circuit detailed herein may be realized as two (or more) separate entities with equivalent functionality, among others.

As used herein, “memory” is understood as a computer-readable medium in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, among others, or any combination thereof. Registers, shift registers, processor registers, data buffers, among others, are also embraced herein by the term memory. The term “software” refers to any type of executable instruction, including firmware.

The term “terminal device” utilized herein refers to user-side devices (both portable and fixed) that can connect to a core network and/or external data networks via a radio access network. “Terminal device” can include any mobile or immobile wireless communication device, including User Equipments (UEs), Mobile Stations (MS s), Stations (STAs), cellular phones, tablets, laptops, personal computers, wearables, multimedia playback and other handheld or body-mounted electronic devices, consumer/home/office/commercial appliances, vehicles, and any other electronic device capable of user-side wireless communications.

Various aspects of this disclosure may utilize or be related to radio communication technologies. While some examples may refer to specific radio communication technologies, the examples provided herein may be similarly applied to various other radio communication technologies, both existing and not yet formulated, particularly in cases where such radio communication technologies share similar features as disclosed regarding the following examples. For purposes of this disclosure, radio communication technologies may be classified as one of a Short Range radio communication technology or Cellular Wide Area radio communication technology. Short Range radio communication technologies may include Bluetooth, WLAN (e.g., according to any IEEE 802.11 standard), and other similar radio communication technologies. Cellular Wide Area radio communication technologies may include Global System for Mobile Communications (GSM), Code Division Multiple Access 2000 (CDMA2000), Universal Mobile Telecommunications System (UMTS), Long Term Evolution (LTE), General Packet Radio Service (GPRS), Evolution-Data Optimized (EV-DO), Enhanced Data Rates for GSM Evolution (EDGE), High Speed Packet Access (HSPA; including High Speed Downlink Packet Access (HSDPA), High Speed Uplink Packet Access (HSUPA), HSDPA Plus (HSDPA+), and HSUPA Plus (HSUPA+)), Worldwide Interoperability for Microwave Access (WiMax), 5G New Radio (NR), for example, and other similar radio communication technologies. Cellular Wide Area radio communication technologies also include “small cells” of such technologies, such as microcells, femtocells, and picocells. Cellular Wide Area radio communication technologies may be generally referred to herein as “cellular” communication technologies.

Unless explicitly specified, the term “transmit” encompasses both direct (point-to-point) and indirect transmission (via one or more intermediary points). Similarly, the term “receive” encompasses both direct and indirect reception. Furthermore, the terms “transmit”, “receive”, “communicate”, and other similar terms encompass both physical transmission (e.g., the transmission of radio signals) and logical transmission (e.g., the transmission of digital data over a logical software-level connection). For example, a processor or controller may transmit or receive data over a software-level connection with another processor or controller in the form of radio signals, where the physical transmission and reception is handled by radio-layer components such as RF transceivers and antennas, and the logical transmission and reception over the software-level connection is performed by the processors or controllers. The term “communicate” encompasses one or both of transmitting and receiving, i.e. unidirectional or bidirectional communication in one or both of the incoming and outgoing directions. The term “calculate” encompass both ‘direct’ calculations via a mathematical expression/formula/relationship and ‘indirect’ calculations via lookup or hash tables and other array indexing or searching operations.

Communication terminals such as e.g. User Equipments (UEs) are potential data collection points to gather more localized data analytics within the network.

Various aspects of this disclosure may provide efficient solutions for gathering and providing radio communication network operational data, e.g. UE data, which may then be processed and used to control and optimize the network.

As an example, providing UE data may be achieved by using a communication device management protocol such as the Lightweight-Machine-to-Machine, LwM2M, protocol as specified by the Open Mobile Alliance, OMA.

Using a device management protocol such as LwM2M may facilitate providing UE data for advanced analytics, and using the same for improving network performance.

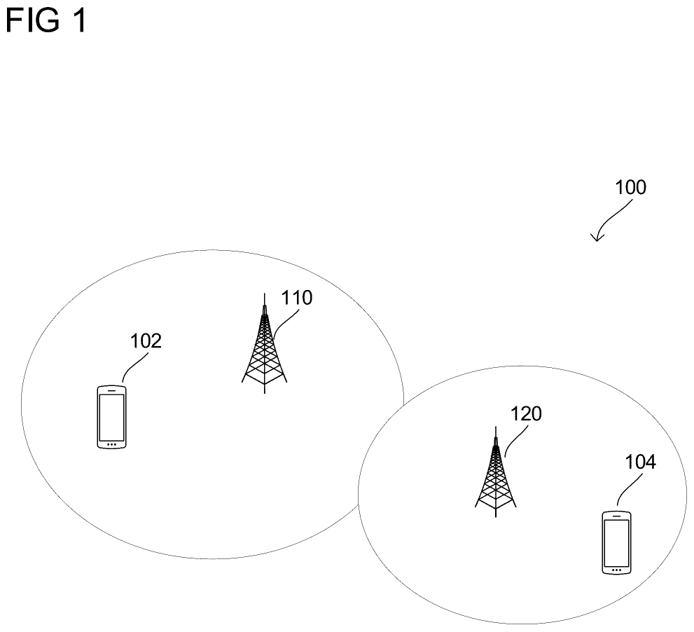

FIG. 1 depicts a general communication network and device architecture for wireless communications. FIG. 1 shows an exemplary radio communication network 100 according to some aspects, terminal devices 102 and 104 and network access nodes 110 and 120. Radio communication network 100 may communicate with terminal devices 102 and 104 via network access nodes 110 and 120 over a radio access network. Although certain examples described herein may refer to a particular radio access network context, these examples are demonstrative and may therefore be readily applied to any other type or configuration of radio access network. The number of network access nodes and terminal devices in radio communication network 100 is exemplary and is scalable to any amount.

In an exemplary cellular context, network access nodes 110 and 120 may be base stations (e.g., gNodeBs, eNodeBs, NodeBs, Base Transceiver Stations (BTSs), or any other type of base station). Terminal devices 102 and 104 may be cellular terminal devices (e.g., Mobile Stations (MS s), User Equipments (UEs), or any type of cellular terminal device) or Internet of Things (IoTs) devices and/or mobile Internet of Things (mIoTs) devices, or cloud clients or Time-Sensitive Networking, TSN, clients. Network access nodes 110 and 120 may interface (e.g., via backhaul interfaces) with a cellular core network such as an 5G Core (5GC, for 5G), Evolved Packet Core (EPC, for LTE), Core Network (CN, for UMTS), or other (cellular) core networks, which may also be considered part of radio communication network 100. The (cellular) core network may interface with one or more external data networks.

Network access nodes 110 and 120 (and, optionally, other network access nodes of radio communication network 100 not explicitly shown in FIG. 1) may accordingly provide a radio access network to terminal devices 102 and 104 (and, optionally, other terminal devices of radio communication network 100 not explicitly shown in FIG. 1). In an exemplary cellular context, the radio access network provided by network access nodes 110 and 120 may enable terminal devices 102 and 104 to wirelessly access the core network via radio communications. The core network may provide switching, routing, and transmission, for traffic data related to terminal devices 102 and 104, and may further provide access to various internal data networks (e.g., control nodes, routing nodes that transfer information between other terminal devices on radio communication network 100, etc.) and external data networks (e.g., data networks providing voice, text, multimedia (audio, video, image), and other Internet and application data).

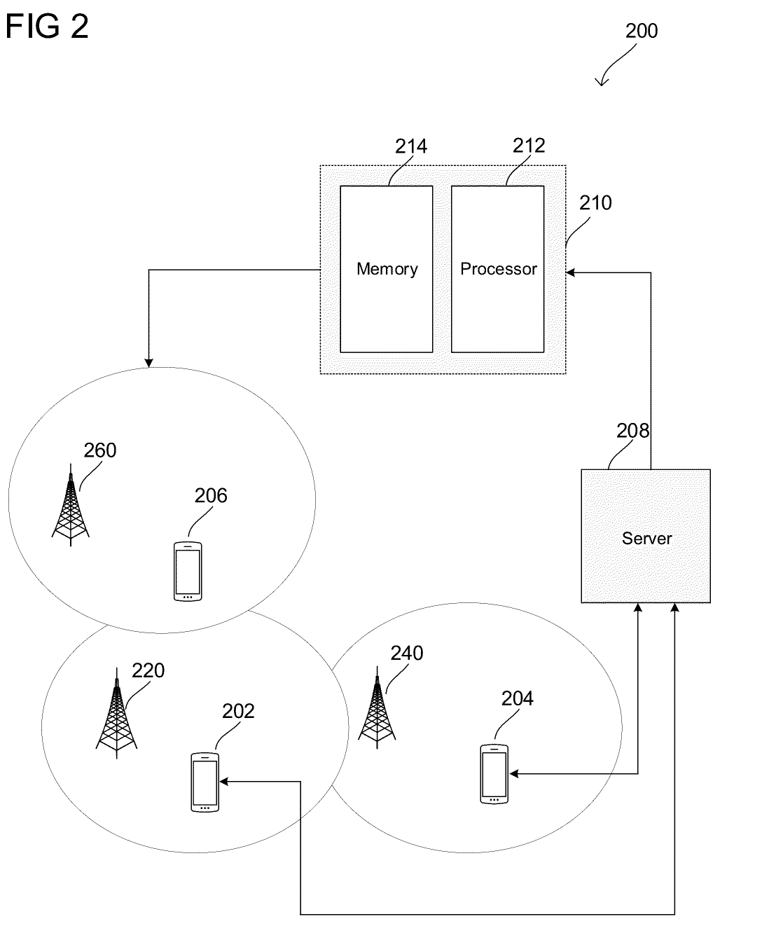

FIG. 2 illustrates an exemplary radio communication network 200, terminal devices 202, 204 and 206, network access nodes 220, 240 and 260, server 208 and device 210.

Radio communication network 200 may communicate with terminal devices 202, 204 and 206 via network access nodes 220, 240 and 260, respectively.

Terminal devices 202, 204 and 206 may e.g. be UEs or mIoTs devices/clients configured to communicate with server 208 via a communication device management protocol, e.g. via an OMA Device Management protocol or via the LwM2M protocol (in accordance with the OMA specification) to share device/UE information in terms of Management Objects (MO). Device 210 may communicate with server 208 and may use/leverage the device/UE information from server 208.

The LwM2M protocol is a Constrained Application Protocol (CoAP), and therefore, when the LwM2M protocol is used, terminal devices 202, 204 and 206 may communicate with server 208 via CoAP and/or via Datagram Transport Layer Security (DTLS) and/or via Short Message Service (SMS).

Terminal devices 202 and 204 are configured to send radio network operational data, e.g. UE data, to server 208 via a communication device management protocol such as e.g. the LwM2M protocol. The data may first be sent to a server 208, e.g. a LwM2M server such as LwM2M server 310 and later leveraged by device 210.

Device 210 includes a processor 212. According to some aspects, device 210 may also include a memory 214 configured to store the received data. According to further aspects, device 210 may include a server, e.g. a LwM2M server such as LwM2M server 310 (not shown).

Device 210 receives the data, e.g. LwM2M objects, from server 208 (and/or from terminal devices 202 and 204). Device 210 is configured to (pre-)process the received data and to determine, on the basis of said received data, communication network operation parameters used to control the operation of the communication network 200, e.g. in order to improve network efficiency. Device 210 then transmits the determined control parameters to a network node, such as e.g. network node 260 (and further network nodes not explicitly shown in FIG. 2) via a communication protocol, e.g. a management device protocol, e.g. the LwM2M protocol. The determination of the communication network control parameters may e.g. be based on statistical analysis of the received data and/or machine learning algorithms.

Device 210 may further be configured to transmit the data and/or the determined control parameters to other network and application functions, such as e.g. the network data analytics function, NWDAF, in the case of a 5G communication network.

In the following, the OMA LwM2M protocol is used as an example for a communication device management protocol. These examples are demonstrative in nature, and may therefore be readily applied to any other type of (communication) device management protocol. As alternative, the OMADM (Open Mobile Alliance Device Management) protocol may be used in various aspects.

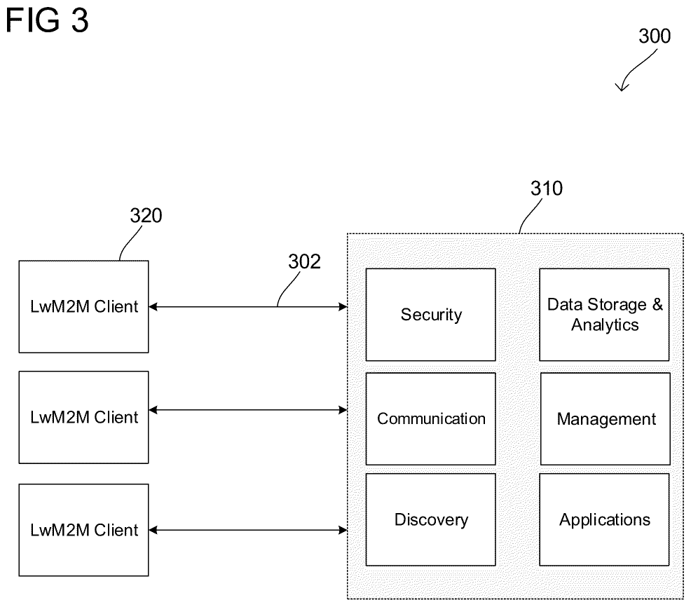

FIG. 3 is an illustration 300 of an exemplary LwM2M server and LwM2M clients. Network operator may host LwM2M Server 310. LwM2M Server 310 is configured to communicate with one or more LwM2M clients 320 via a communication device management protocol 302, in this example, via the LwM2M protocol 302 (and/or via CoAP, DTLS or SMS). LwM2M client 320 may communicate with LwM2M server 310 via a cellular or WiFi radio access network or via short range communication technologies (such as e.g. WLAN (e.g., according to any IEEE 802.11 standard), Low-Power WPAN such as 6LoWPAN, and other similar radio communication technologies).

According to various aspects, LwM2M server 310 and LwM2M clients 320 may be configured in accordance with an OMA LwM2M server and client.

The LwM2M server 310 includes security, communication, discovery, data storage & analytics, management and applications modules (in accordance with the OMA specification).

An LwM2M client 320 may for example be a UE, an MS (or any type of cellular terminal device), an IoT device, a mIoT device, a cloud client or a TSN client.

If a device is LwM2M capable, i.e. is compatible with the LwM2M protocol, such as LwM2M clients 320, it will be able to provide data such as Location profile, Connectivity Statistics, Cellular Connectivity, APN Connection Profile, Bearer Selection and various other LwM2M objects to the LwM2M server 310. Network operators may then use this information for (pre-)processing, storing and running statistical analysis and machine learning algorithms in order to achieve various network optimizations, such as a better understanding of network overload scenarios, improving the existing network performance, identifying the most profitable customers, etc. According to various aspects, the LwM2M server 310 may send the data (LwM2M objects) received from LwM2M clients 320 to a device such as device 210. Device 210 is configured to process the received data, and to output network operations parameters used for controlling and optimizing the network.

LwM2M objects have been enhanced to accommodate devices operating in Narrowband-IoT (NB-IoT) networks. Multiple device OEM can therefore use LwM2M resources defined as part of standard LwM2M objects to capture the data received from terminal communication devices such as UEs.

More details on some LwM2M objects, associated resources & how the information can be used by network operators is summarized in Table 1 below.

TABLE 1
LwM2M objects, parameters & Network Optimization

| LwM2M | | | |
|---|---|---|---|
| Objects | Parameters | Description | Network Optimization |
| Connectivity | Network Bearer, | Enables monitoring of | QoS Profile Provisioning |
| Monitoring | Available Network | parameters related to | Radio Signal Strength, Link |
| (urn:oma:lwm2m:oma:4) | Bearer, Radio | network connectivity. | Quality & Network Bearer details |
| | Signal Strength, | Network Bearer can | can assist PCF for determining |
| | Link Quality, IP | contain NB-IoT. The Link | QoS |
| | Addresses, Router | Quality Resource can also | Supervision of mIoT terminals |
| | IP Addresses, Link | contain received link | & determination of profitable |
| | Utilization, APN, | quality, i.e., NRSRQ for | customers |
| | Cell ID, SMNC, | NB-IoT & Radio Signal | Cell ID, SMNC, SMCC can help |
| | SMCC | Strength can also contain | for supervision on mIOT |
| | | NRSRP for NB-IoT. | terminals. |
| | | | Handover decision & Network |
| | | | Upgrade requirements |
| | | | Radio Signal Strength, Link |
| | | | Quality, Network Bearer details |
| | | | can assist handovers |
| Connectivity | SMS Tx Counter, | This LwM2M Object | UE behavioral information |
| Statistics | SMS Rx Counter, | enables client to collect | provisioning |
| (urn:oma:lwm2m:oma:7) | Tx Data, Rx Data, | statistical information | Based on all parameters, |
| | Max Message Size, | and enables the LwM2M | operators can derive UE |
| | Average Message | Server to retrieve this | behavioral information and create |
| | Size, Collection | information, set the | UE clusters for similar behaviors. |
| | period, Start & Stop | collection duration and | Traffic routing & determining |
| | | reset the statistical | overloaded/under-utilized |
| | | parameters. | networks |
| | | | Tx Data & Rx Data can help in |
| | | | traffic routing to balance the |
| | | | network load. |
| 5GNR | | Used for 5g-NR capable | QoS Profile Provisioning |
| Connectivity | | devices, gives details of NR | S-NSSAI, SSC Mode, 5QI & |
| (urn:oma:lwm2m:oma:27) | | supported band, S-NSSAI, | QoS can help in QoS Profile |
| | | DNN Name, PDU session | Provisioning. |
| | | id, SSC Mode, 5QI, QoS, | Traffic routing |
| | | etc. | QoS, 5QI (5QI defines packet |
| | | | loss rate, packet delay budget, |
| | | | etc.) can help in assisting |
| | | | traffic routing. |
| Device | Manufacturer, | This LwM2M Object | Supervision of IoT terminals & |
| (urn:oma:lwm2m:oma:3) | Model Number, | provides a range of device | determination of profitable |
| | Serial Number, | related information which | customers |
| | Firmware Version, | can be queried by the | Device information along with |
| | Factory Reset, | LwM2M Server, and a | other LwM2M objects can help to |
| | Available Power | device reboot and factory | create UE behavioral information |
| | Source, Current | reset function. | profile and help in supervision of |
| | Time, Hardware | | IOT terminal |
| | Version, Battery | | |
| | Status, etc. | | |
| Location | Latitude, Longitude, | This LwM2M Object | Supervision of IoT terminals & |
| (urn:oma:lwm2m:oma:6) | Altitude, Radius, | provides location | Network Upgrade |
| | Velocity, | information of the UE. | requirements |
| | Timestamp, Speed. | | Location incorporated with other |
| | | | objects reported by device, help |
| | | | to supervise and create location- |
| | | | based UE's profiling & determine |
| | | | upgrade requirements. |
| Cellular | SMSC address, | This object specifies | Handover decision |
| Connectivity | disable radio period, | resources to enable a device | Used in achieving informed |
| (urn:oma:lwm2m:oma:10) | Module activation | to connect to a 3GPP or | handover decisions as it captures |
| | code, Vendor | 3GPP2 bearer, including | the details of enabling a |
| | specific extensions, | GPRS/EDGE, UMTS, | connection. |
| | PSM Timer, Active | LTE, NB-IoT, SMS. | |
| | Timer, Serving | | |
| | PLMN Rate control, | | |
| | eDRX parameters | | |
| | for NB-S1 mode | | |
| | (1), Activated | | |
| | Profile Names, etc. | | |
| LWM2M | Preferred | Specifies resources to | UE behavioral information |
| Bearer | Communications | enable a device to choose a | provisioning |
| Selection | Bearer, Acceptable | PLMN/network on which | Acceptable RSRP & List of |
| (urn:oma:lwm2m:oma:13) | RSRP, List of | to register. This allows via | available PLMNs helps in |
| | available PLMNs | remote bearer and network | creating similar UE clusters for |
| | etc. | configuration to overwrite | improving network efficiency |
| | | automatic network/bearer | |
| | | selection e.g. as supported | |
| | | by the UICC. | |

Thus, the information captured by LwM2M objects may be used for several network optimizations, such as QoS profile provisioning, supervision of (m)IoT terminals, handover decisions, traffic routing, UE behavioral information provisioning, determining overloaded and/or under-utilized networks, determining profitable customers, determining network upgrade requirements, etc.

For example, analytics information derived by QoS and/or by 5QI (5G QoS Identifier) such as Location, Radio Signal Strength, Link Quality, etc., can be used to find low coverage areas for UE clusters. The network operator may then improve radio coverage conditions in general or at the locations where the UEs lose service and/or have low coverage. In a multi-RAT scenario, the data collected from the terminal devices may be used to improve the connectivity experience of devices and to optimize their power consumption.

Further possible use cases are for example the following:
1) Using Device & Location details to supervise mIoT terminals and/or to use this information to push location specific profiles to Device by Operators.
2) QoS Profile Provisioning: a QoS flow is characterized by a QoS profile provided by the 5GC to a 5G-RAN and QoS rule(s) provided by the 5GC to the UE. 5G Network can provide the UE with one or more QoS flow descriptions associated with a PDU session during the PDU session establishment or at the PDU session modification. UE specific data provided by LwM2M is helpful for the network to be able to derive these QoS flow which define Flow Bit rate & Maximum Packet Loss Rate.
3) Determining profitable customers: Device Details along with Connectivity Statistics provided by various LwM2M Management objects can be utilized by operators to determine the valuable/profitable customers.
4) Handover Decisions: Network triggered handover decisions can be optimized by considering the Connectivity Statistics of the UEs. For example, Radio Signal Strength, Link Quality and Network Bearer details may assist handovers.

With minimal changes, most terminal devices such as e.g. UEs, can be made LwM2M capable and can implement a LwM2M client. As long as the terminal devices support a device management protocol such as e.g. the LwM2M protocol, they can contribute to optimizing the network. In Multi-RAT scenarios, the performance and connectivity experience can also be improved by using and processing the LwM2M objects received from terminal devices. Thus, with minimal changes to the terminal devices, and with no changes to 3GPP standards and to existing network nodes, device management protocols such as LwM2M can be implemented not only in 5G networks, but also in all types of networks and network generations, such as e.g. GSM, UMTS and LTE. The only change required to terminal devices is to implement a LwM2M client and to support the Management Objects listed in Table 1.

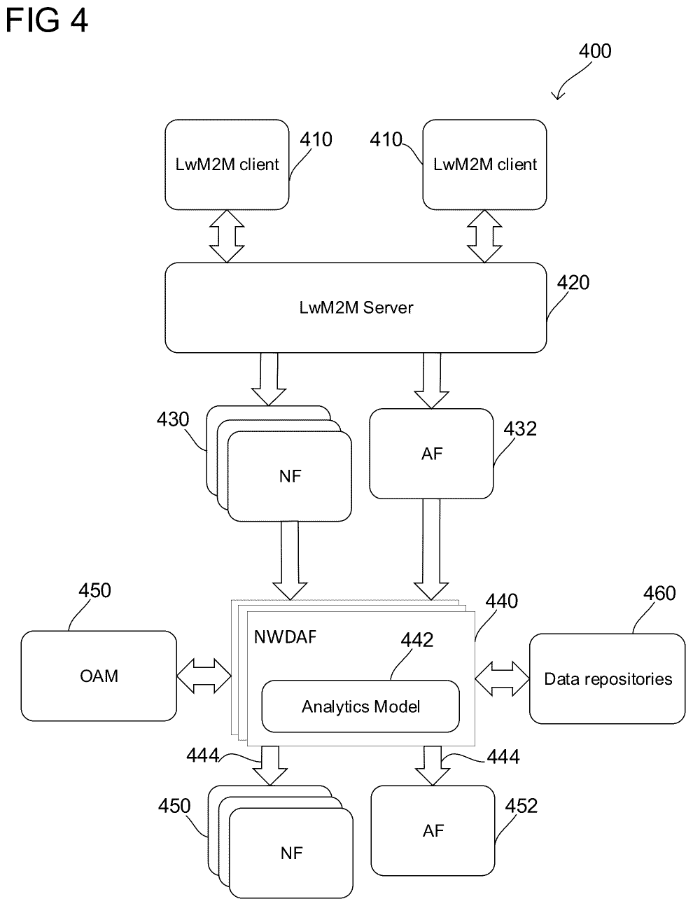

FIG. 4 illustrates an exemplary implementation 400 of a LwM2M server 420 into a 5G core network. The general framework for the NWDAF to be able to collect data from the operator OAM, AFs and 5GC network functions may be configured in accordance with in 3GPP TR 23.791 V16.2.0 (2019-06).

In FIG. 4, LwM2M clients 410, such as e.g. terminal devices 102, 104 or terminal devices 202, 204 are configured to communicate with LwM2M server 420 via a LwM2M protocol. The server 420 is configured to receive real time localized data in the form of LwM2M objects from the LwM2M clients 410. The server 420 may e.g. be a server such as LwM2M server 310. The gathered data/LwM2M objects are then output to Network Functions, NFs, 430 and Application Functions, AFs, 432, which are functions of the SGC. The NFs 430 and AFs 432 in turn are configured to collect the information from the LwM2M server 420, process it, and forward it in the form of e.g. activity data and local analytics data (based on the received LwM2M objects) to the NWDAF 440. According to some aspects, the NWDAF 440 may further be configured to communicate with an Operations, Administration and Management, OAM, entity 450 and with data repositories 460. After processing the data received from the NFs 430 and AFs 432 via analytics model 442, the NWDAF 440 may output analytics data 444 to NFs 450 and AFs 452. NFs 450, AFs 452, or other functions/devices may then use the output analytics data to control and optimize the 5G RAN, and e.g. to improve the network services in terms of user experience, efficiency and performance.

The above exemplary implementation is 5G specific, however, as long as terminal devices are compatible with (communication) device management protocols such as the LwM2M protocol, an LwM2M server such as server 310 and server 420 may be implemented into any type of communication network, i.e. in any type of Cellular Wide Area radio communication technologies or Short Range radio communication technologies network. In general, network operators may use data hosted in an LwM2M server for data analytics and thereby optimize the network, improve decisions regarding deployments and to better scale the network infrastructure.

In non-5G communication networks, LwM2M server 420 may for example be configured to send the gathered LwM2M objects to a device such as device 210, which is configured to process the received LwM2M objects and to output network operation parameters to control and optimize the operation of the communication network.

The new components for supporting data reporting by a device management protocol such as the LwM2M protocol may be compliant with the 3GPP specifications TS 26.531 V17.1.0 (2022-09)) and TS 26.532 V17.1.0 (2022-09). The LwM2M server may for example include either a direct data collection client or an indirect data collection client in order to provide the data to further AF/NFs. The data collection client is a functional entity defined by 3GPP that is configured to collect data and to report it to a data collection AF via a direct or an indirect client.

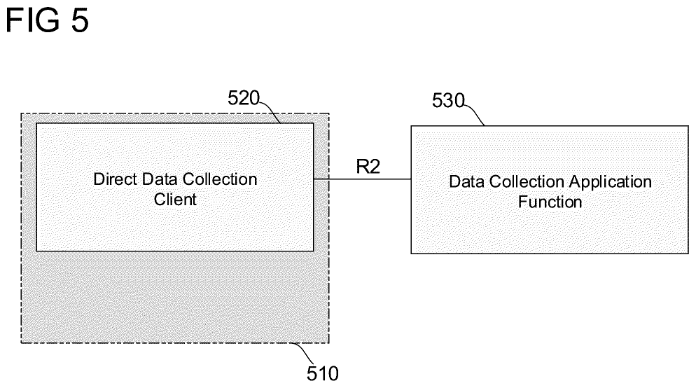

FIG. 5 illustrates an exemplary implementation of a LwM2M server including a direct data collection client. In FIG. 5, LwM2M server 510 includes a direct data collection client 520, which is configured to communicate with (an instance of) data collection AF 530 via reference point R2. The standard Ndcaf_DataReporting service is used for the communication between the direct data collection client 510 and data collection AF 530, whereby the direct data collection client 520 obtains data collection and reporting configuration via reference point R2 from the data collection AF 530, and sends (data) reports to its corresponding data collection AF 530 instance by means of the standard Ndcaf_DataReporting service. The data collection AF 530 is further configured to send the processed data to event notifications such as e.g. the NWDAF.

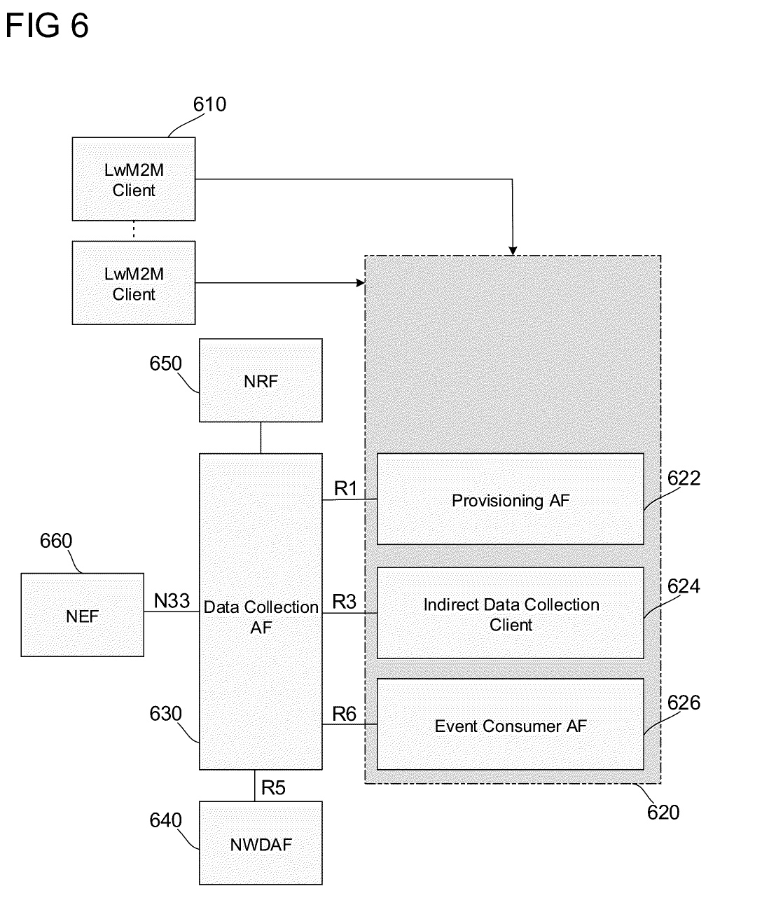

FIG. 6 illustrates an exemplary implementation of a LwM2M server including an indirect data collection client. In FIG. 6, LwM2M clients 610 provide data in the form of LwM2M objects to LwM2M server 620. The LwM2M server 620 includes a Provisioning AF 622. The Provisioning AF 622 communicates with data collection AF 630 via reference point R1. The standard Ndcaf_DataReportingProvisioning service as defined in 3GPP specifications TS 26.531 V17.1.0 (2022-09) and TS 26.532 V17.1.0 (2022-09) may be provided by the data collection AF 630 for this purpose. The data collection AF 630 is responsible for managing the provisioning state for data collection and reporting, and provides data collection and reporting configuration to the indirect data collection client 624 at reference point R3. R3 is used by an indirect data collection client 624 instance to obtain its data collection and reporting configuration from the corresponding data collection AF 630 instance by means of the standard Ndcaf_DataReporting service. R3 is further used by the indirect data collection client 624 to send data reports to its corresponding data collection AF 630 instance by means of the standard Ndcaf_DataReporting service. The data collection AF 630 processes the received data reports according to processing instructions in its provisioning state. The processing activities may include, but are not limited to, reporting format conversion, data normalization, reporting domain-specific anonymization of data and (dis)aggregation of data into reports (to be sent as events). The data collection AF 630 is responsible for sending the processed data to event notification subscribers such as the NWDAF 640. The data collection AF 630 may further also be configured to communicate with Network Repository Function, NRF, 650 and via reference point N33 with Network Exposure Function, NEF, 660.

Optionally, the LwM2M server 620 may also include an Event Consumer AF 626, which is configured to communicate with the data collection AF 630 via reference point R6.

The 3GPP Specification TR 23.791, section 6.6, defines a solution for the NWDAF to interact with 5G NFs/AFs for data collection. According to some aspects, the LwM2M server may be configured to use the same framework to provision information to the NWDAF. The NFs/AFs may receive data (LwM2M objects) from the LwM2M server and may provide periodically, according to a subscription, a list of data blocks called Collectable Data Items (CDIs) to the NWDAF. This enables providing a generic service interface (Data Collection Service) offering the following operations in accordance with Table 2.

TABLE 2
Operations Provided by Data Collection Service

| Operations | Description of each operation |
|---|---|
| Subscribe | Subscription to a subset of existing CDIs computed by the |
| | NF with LwM2M data |
| Update | Update of a specific subscription |
| Unsubscribe | Cancelling of a specific subscription |
| Notify | CDI(s) is sent to the user(s) |
| Retrieve | A user explicitly requests the CDI(s) and receives the |
| | requested information |

When a subscription is accepted, an AF/NF notifies of the requested CDIs to the NWDAF. Each notification may contain either a single timestamped set of instances of CDIs, or information on a file containing several instances. The CDIs can be made available on a periodical time frame basis, depending on the subscription parameters, or it can be requested by the NWDAF within a time frame.

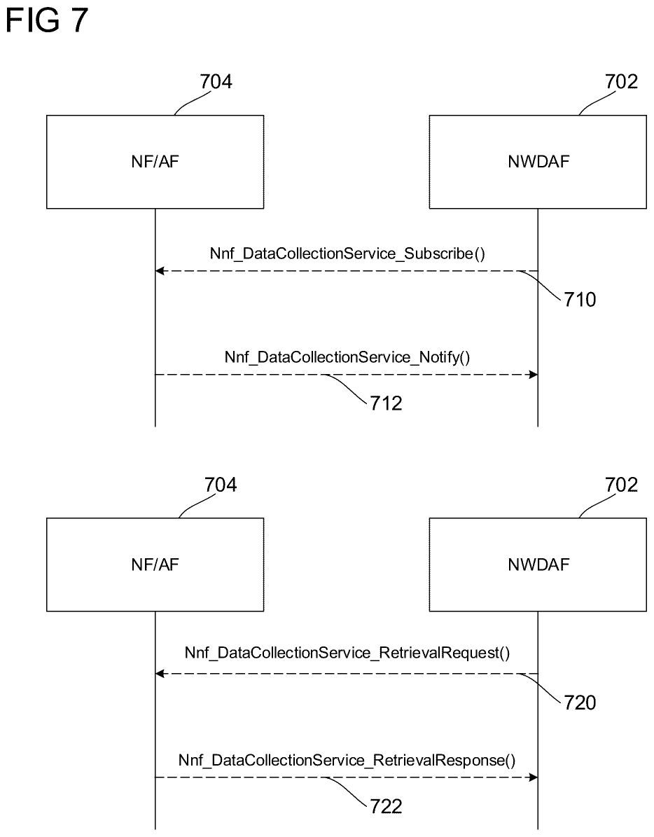

FIG. 7 illustrates exemplary interactions (communication) between the NWDAF 702 and 5GC NFs/AFs 704 using LwM2M server data for data collection. As illustrated in FIG. 7, the Nnf_DataCollectionService_Subscribe( ) function 710 and the Nnf_DataCollectionService_Notify( ) function 712, as well as the Nnf_DataCollectionService_RetrievalRequest( ) function 720 and the Nnf_DataCollectionService_RetrievalResponse( ) function 722 may be used for the communication between the NWDAF 702 and NFs/AFs 704 of the 5GC.

Using device management protocols such as the LwM2M protocol for communication further provides several effects regarding the security and integrity of the collected data, as well as further privacy aspects which have to be considered when using data from terminal devices such as UEs for data analytics. In the following, a few of these effects will be explained in details.

The LwM2M protocol may include authorization, authentication, confidentiality, and data integrity for the communication between LwM2M entities, whereby, from the perspective of the LwM2M protocol stack, TLS/DTLS provides the main security mechanism, and from the perspective of the transport layer for the application layer the communication protocol CoAP provides security. In order to use these features, LwM2M clients are required to acquire credentials and configuration information, in order to ensure secure communications with LwM2M servers through a bootstrapping process.

The LwM2M framework may therefore include a LwM2M bootstrap server providing key material used to protect the communication between LwM2M clients and LwM2M servers. In accordance with the OMA LwM2M v1.1 specification, LwM2M may be extended with an application-layer security using Object Security for Constrained RESTful Environments (OSCORE), which offers a unified mechanism usable across a multitude of platforms, use cases and industries. OSCORE is a security protocol, e.g. an IoT security protocol, that protects the CoAP message exchanges, and provides end-to-end security even with proxies in the service path between two LwM2M endpoints, or with different transports in the path. In addition to CoAP, OSCORE uses Concise Binary Object Representation (CBOR) for compact encoding and CB OR Object Signature and Encryption (COSE).

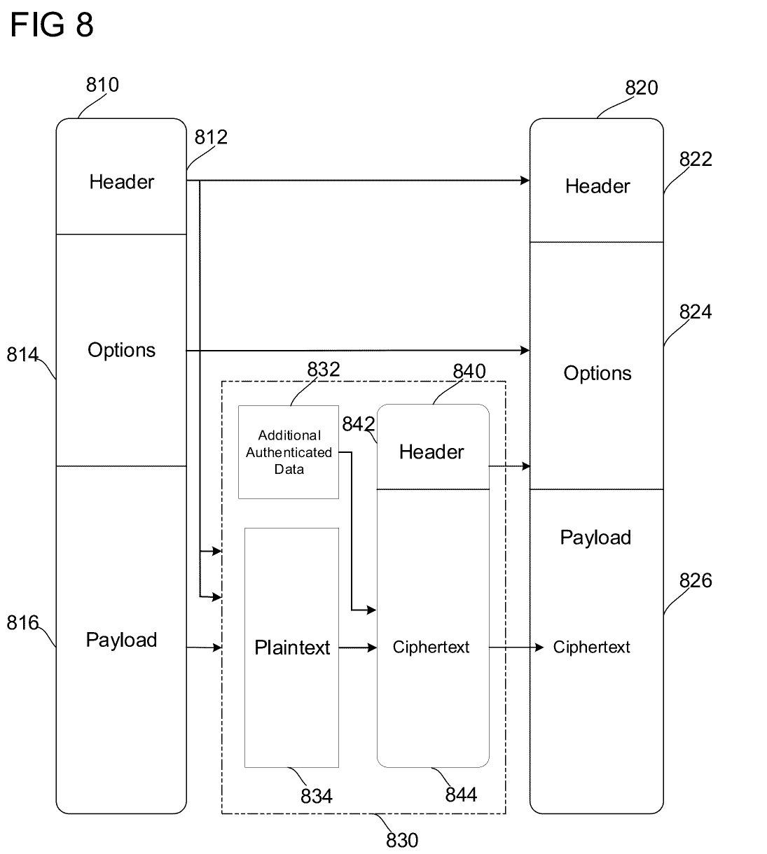

FIG. 8 illustrates the protection of LwM2M communication using the OSCORE security protocol. In FIG. 8, a CoAP message 810 includes the fields: Header 812, (CoAP) Options 814 and Payload 816. The CoAP message 810 is transmitted to the COSE processing unit 830, where the header, options and payload fields are transformed into plaintext 834, and where the CoAP message 810 is encrypted and integrity protected as a COSE object 840 including a header 842 and ciphertext 844, i.e. encrypted text. It should be noted, that only certain CoAP options and some of the header fields are encrypted and integrity protected together with the payload/text of the message. The COSE processing unit 830 requires additional authenticated data 832 for the encryption and integrity protection. The result of using OSCORE on CoAP message 810 is a protected CoAP message 820, containing a header field 822, an options field 824 (not necessarily containing all same options/fields as CoAP message 810) and a payload field 826 now containing ciphertext.

The above described features ensure that only authorized endpoints controlled by the bootstrapping process may participate in the communication. The TLS/DTLS & application layer security using OSCORE further ensures that the data is not tampered.

The security of the LwM2M communication is based on CoAP, and utilizes DTLS as its main security mechanism. Along with UDP and SMS transport channel bindings, DTLS implements authentication, confidentiality and data integrity between server and client and includes 3 main security modes: certificates, raw public keys and pre-shared keys. The client is required to have credentials and configuration information obtained during the bootstrapping process. Once the bootstrap is done, the server authenticates the client, enabling the client to use security features supported by LwM2M.

The LwM2M protocol may further offer protection of personal data, so-called Personally Identifiable Information (PII), by using communication security and access control mechanisms. By way of example, the leakage of stored IoT device data in the LwM2M servers is avoided by LwM2M security features, the lifecycle management of LwM2M endpoints and the frequent firmware and software updates on the terminal communication devices via e.g. the Firmware Over-The-Air, FOTA, feature.

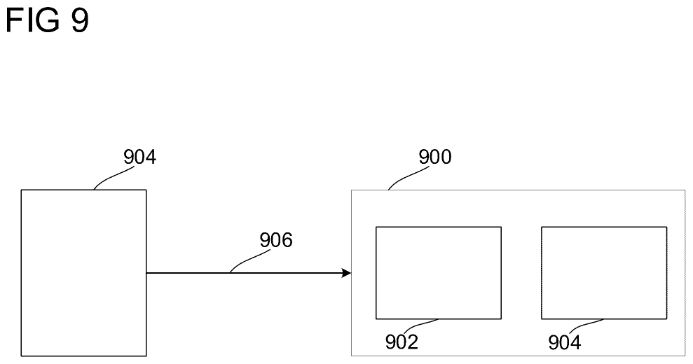

FIG. 9 illustrates an exemplary device 900 for operating a radio communication network according to some aspects. As shown in FIG. 9, device 900 includes a processor 902 and a memory 904 to store the radio communication network operational data, wherein processor 902 is configured to receive radio communication network operational data from at least one communication terminal 906 in accordance with a communication device management protocol 908, and is configured to determine communication network operation parameters to control the operation of the communication network based on the received radio communication network operational data.

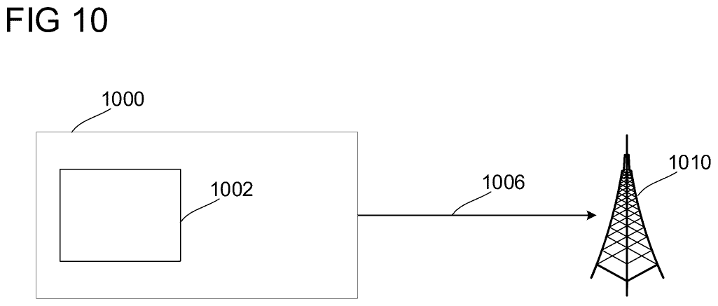

FIG. 10 illustrates an exemplary terminal communication device 1000. As shown in FIG. 10, terminal communication device 1000 includes a processor 1002, wherein processor 1002 is configured to determine radio communication network operational data for one or more radio communication connections with a radio communication network 1010, and is configured to send the determined radio communication network operational data to the radio communication network 1010 in accordance with a communication device management protocol 1006 to thereby enable the radio communication network 1010 to control the operation of the communication network 1010.

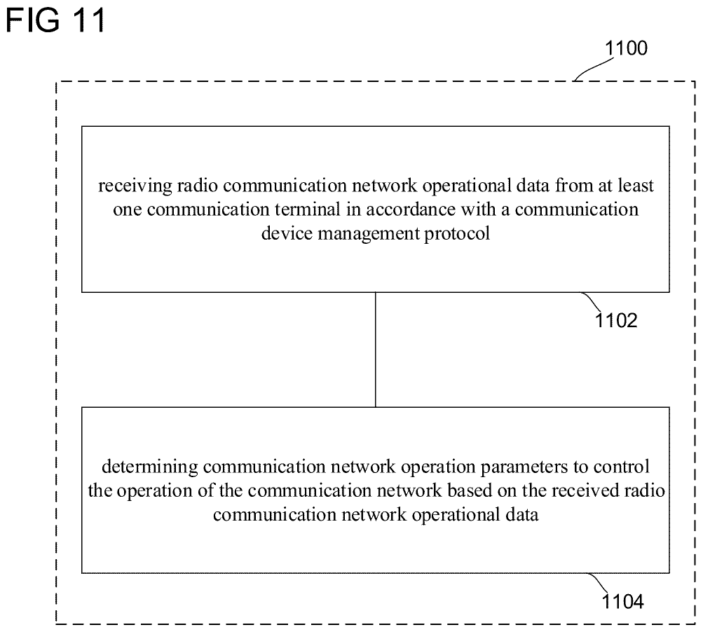

FIG. 11 shows a flowchart illustrating a method 1100 for operating a device according to some aspects, e.g. device 210 illustrated in FIG. 2 or device 900 illustrated in FIG. 9. As shown in FIG. 11, method 1100 for operating a radio communication network includes receiving 1102 radio communication network operational data from at least one communication terminal in accordance with a communication device management protocol; and determining 1104 communication network operation parameters to control the operation of the communication network based on the received radio communication network operational data.

While the above descriptions and connected figures may depict electronic device components as separate elements, skilled persons will appreciate the various possibilities to combine or integrate discrete elements into a single element. Such may include combining two or more circuits for form a single circuit, mounting two or more circuits onto a common semiconductor chip or chassis to form an integrated element, executing discrete software components on a common processor core, etc. Conversely, skilled persons will recognize the possibility to separate a single element into two or more discrete elements, such as splitting a single circuit into two or more separate circuits, separating a semiconductor chip or chassis into discrete elements originally provided thereon, separating a software component into two or more sections and executing each on a separate processor core, etc.

It is appreciated that implementations of methods detailed herein are demonstrative in nature, and are thus understood as capable of being implemented in a corresponding device. Likewise, it is appreciated that implementations of devices detailed herein are understood as capable of being implemented as a corresponding method. It is thus understood that a device corresponding to a method detailed herein may include one or more components configured to perform each aspect of the related method.

All acronyms defined in the above description additionally hold in all claims included herein.

The following examples disclose various aspects of this disclosure:

Example 1 is a device for operating a radio communication network. The device may include a processor configured to receive radio communication network operational data from at least one communication terminal in accordance with a communication device management protocol, and to determine communication network operation parameters to control the operation of the communication network based on the received radio communication network operational data.

In Example 2, the subject-matter of Example 1 can optionally include that the device includes a memory, wherein the radio communication network operational data is stored in the memory.

In Example 3, the subject-matter of any one of Examples 1 or 2 can optionally include that the communication device management protocol is a Lightweight Machine-to-Machine, LwM2M, protocol including at least one LwM2M object.

In Example 4, the subject-matter of Example 3 can optionally include that the communication network operational data received from the at least one communication terminal in accordance with the LwM2M protocol includes at least one of the following LwM2M objects: Connectivity Monitoring, Connectivity Statistics, 5GNR Connectivity, Device, Location, Cellular Connectivity and LwM2M Bearer Selection; and that the received radio communication network operational data includes at least one LwM2M object.

In Example 5, the subject-matter of Example 4 can optionally include that each received LwM2M object includes at least one parameter, wherein
the Connectivity Monitoring object parameters include any of: Network Bearer, Available Network Bearer, Radio Signal Strength, Link Quality, IP Addresses, Router IP Addresses, Link Utilization, APN, Cell ID, SMNC and SMCC;
the Connectivity Statistics object parameters include any of: SMS Tx Counter, SMS Rx Counter, Tx Data, Rx Data, Max Message Size, Average Message Size, Collection Period and Start & Stop;
the Device object parameters include any of: Manufacturer, Model Number, Serial Number, Firmware Version, Factory Reset, Available Power Source, Current Time, Hardware Version and Battery Status;
the Location object parameters include any of: Latitude, Longitude, Altitude, Radius, Velocity, Timestamp and Speed;
the Cellular Connectivity object parameters include any of: MSC address, disable radio period, Module activation code, Vendor specific extensions, PSM Timer, Active Timer, Serving PLMN Rate control, eDRX parameters for NB-S1 mode and Activated Profile Names; and
the LwM2M Bearer Selection object parameters include any of: Preferred Communications Bearer, Acceptable RSRP and List of available PLMNs.

In Example 6, the subject-matter of any one of Examples 1 to 5 can optionally include that controlling the operation of the communication network includes at least one of: determining overloaded and/or under-utilized communication networks, traffic routing, Quality of Service, QoS, profile provisioning, supervision of the at least one communication terminal, handover decisions for the at least one communication terminal, behavioral information of the at least one communication terminal, determining a relevance of the at least one communication terminal, and determining network upgrade requirements.

In Example 7, the subject-matter of any one of Examples 1 to 6 can optionally include that the radio communication network is a Cellular Wide Area radio communication network configured in accordance with a 3GPP standard.

In Example 8, the subject-matter of any one of Examples 1 to 6 can optionally include that the radio communication network is a Short Range radio communication network.

Example 9 is a terminal communication device. The terminal communication device may include a processor configured to determine radio communication network operational data for one or more radio communication connections with a radio communication network, and send the determined radio communication network operational data to the radio communication network in accordance with a communication device management protocol to thereby enable the radio communication network to control the operation of the communication network.

In Example 10, the subject-matter of Example 9 can optionally include that the terminal communication device is an Internet of Things, IoT, terminal and/or that the terminal communication device is a mobile internet of things, mIoT, terminal.

In Example 11, the subject-matter of any one of Examples 9 to 10 can optionally include that the communication device management protocol is a Lightweight Machine-to-Machine, LwM2M, protocol including at least one LwM2M object.

In Example 12, the subject-matter of Example 11 can optionally include that the LwM2M protocol includes at least one of the following LwM2M objects: Connectivity Monitoring, Connectivity Statistics, 5GNR Connectivity, Device, Location, Cellular Connectivity and LwM2M Bearer Selection, and that the received radio communication network operational data includes at least one LwM2M object.

In Example 13, the subject-matter of any one of Examples 9 to 12 can optionally include that each LwM2M object includes at least one parameter, wherein the Connectivity Monitoring object parameters include any of: Network Bearer, Available Network Bearer, Radio Signal Strength, Link Quality, IP Addresses, Router IP Addresses, Link Utilization, APN, Cell ID, SMNC and SMCC;
the Connectivity Statistics object parameters include any of: SMS Tx Counter, SMS Rx Counter, Tx Data, Rx Data, Max Message Size, Average Message Size, Collection Period and Start & Stop;
the Device object parameters include any of: Manufacturer, Model Number, Serial Number, Firmware Version, Factory Reset, Available Power Source, Current Time, Hardware Version and Battery Status;
the Location object parameters include any of: Latitude, Longitude, Altitude, Radius, Velocity, Timestamp and Speed;
the Cellular Connectivity object parameters include any of: MSC address, disable radio period, Module activation code, Vendor specific extensions, PSM Timer, Active Timer, Serving PLMN Rate control, eDRX parameters for NB-S1 mode and Activated Profile Names; and
the LwM2M Bearer Selection object parameters include any of: Preferred Communications Bearer, Acceptable RSRP and List of available PLMNs.

In Example 14, the subject-matter of any one of Examples 9 to 13 can optionally include that controlling the operation of the communication network includes at least one of: determining overloaded and/or under-utilized communication networks, traffic routing, Quality of Service, QoS, profile provisioning, supervision of the at least one communication terminal, handover decisions for the at least one communication terminal, behavioral information of the at least one communication terminal, determining a relevance of the at least one communication terminal, and determining network upgrade requirements.

Example 15 is a method for operating a radio communication network. The method may include receiving radio communication network operational data from at least one communication terminal in accordance with a communication device management protocol, and determining communication network operation parameters to control the operation of the communication network based on the received radio communication network operational data.

In Example 16, the subject-matter of Example 15 can optionally include that the communication device management protocol is a Lightweight Machine-to-Machine, LwM2M, protocol including at least one LwM2M object.

In Example 17, the subject-matter of any one of Examples 15 or 16 can optionally include that receiving radio communication network operational data from at least one communication terminal in accordance with a LwM2M protocol includes receiving at least one of the following LwM2M objects: Connectivity Monitoring, Connectivity Statistics, 5GNR Connectivity, Device, Location, Cellular Connectivity and LwM2M Bearer Selection, and that receiving radio communication network operational data includes receiving at least one LwM2M object.

In Example 18, the subject-matter of Example 17 can optionally include that each LwM2M object includes at least one parameter, wherein the
Connectivity Monitoring object parameters include any of: Network Bearer, Available Network Bearer, Radio Signal Strength, Link Quality, IP Addresses, Router IP Addresses, Link Utilization, APN, Cell ID, SMNC and SMCC;
the Connectivity Statistics object parameters include any of: SMS Tx Counter, SMS Rx Counter, Tx Data, Rx Data, Max Message Size, Average Message Size, Collection Period and Start & Stop;
the Device object parameters include any of: Manufacturer, Model Number, Serial Number, Firmware Version, Factory Reset, Available Power Source, Current Time, Hardware Version and Battery Status;
the Location object parameters include any of: Latitude, Longitude, Altitude, Radius, Velocity, Timestamp and Speed;
the Cellular Connectivity object parameters include any of: MSC address, disable radio period, Module activation code, Vendor specific extensions, PSM Timer, Active Timer, Serving PLMN Rate control, eDRX parameters for NB-S1 mode and Activated Profile Names; and
the LwM2M Bearer Selection object parameters include any of: Preferred Communications Bearer, Acceptable RSRP and List of available PLMNs.

In Example 19, the subject-matter of any one of Examples 15 to 18 can optionally include that controlling the operation of the communication network based on the received radio communication network operational data includes at least one of: determining overloaded and/or under-utilized communication networks, routing traffic, determining Quality of Service, QoS, profile provisioning, supervising the at least one communication terminal, determining handovers for the at least one communication terminal, determining behavioral information of the at least one communication terminal, determining a relevance of the at least one communication terminal, and determining network upgrade requirements.

In Example 20, the subject-matter of any one of Examples 15 to 19 can optionally include that the radio communication network is a Cellular Wide Area radio communication network configured in accordance with a 3GPP standard.

In Example 21, the subject-matter of any one of Examples 15 to 19 can optionally include that the radio communication network is a Short Range radio communication network.

Example 22 is a non-transitory computer readable medium. The non-transitory computer-readable medium may include instructions which, when executed, implements a method for operating a radio communication network, wherein the method includes receiving radio communication network operational data from at least one communication terminal in accordance with a communication device management protocol, and determining communication network operation parameters to control the operation of the communication network based on the received radio communication network operational data.

In Example 23, the subject-matter of Example 22 can optionally include that the communication device management protocol is a Lightweight Machine-to-Machine, LwM2M, protocol including at least one LwM2M object.

In Example 24, the subject-matter of any one of Examples 22 or 23 can optionally include that the communication network operational data received from the at least one communication terminal in accordance with the LwM2M protocol includes at least one of the following LwM2M objects: Connectivity Monitoring, Connectivity Statistics, 5GNR Connectivity, Device, Location, Cellular Connectivity and LwM2M Bearer Selection; and that the received radio communication network operational data includes at least one LwM2M object.

In Example 25, the subject-matter of Example 24 can optionally include that each received LwM2M object includes at least one parameter, wherein
the Connectivity Monitoring object parameters include any of: Network Bearer, Available Network Bearer, Radio Signal Strength, Link Quality, IP Addresses, Router IP Addresses, Link Utilization, APN, Cell ID, SMNC and SMCC;
the Connectivity Statistics object parameters include any of: SMS Tx Counter, SMS Rx Counter, Tx Data, Rx Data, Max Message Size, Average Message Size, Collection Period and Start & Stop;
the Device object parameters include any of: Manufacturer, Model Number, Serial Number, Firmware Version, Factory Reset, Available Power Source, Current Time, Hardware Version and Battery Status;
the Location object parameters include any of: Latitude, Longitude, Altitude, Radius, Velocity, Timestamp and Speed;
the Cellular Connectivity object parameters include any of: MSC address, disable radio period, Module activation code, Vendor specific extensions, PSM Timer, Active Timer, Serving PLMN Rate control, eDRX parameters for NB-S1 mode and Activated Profile Names; and
the LwM2M Bearer Selection object parameters include any of: Preferred Communications Bearer, Acceptable RSRP and List of available PLMNs.

In Example 26, the subject-matter of any one of Examples 22 to 25 can optionally include that controlling the operation of the communication network includes at least one of: determining overloaded and/or under-utilized communication networks, traffic routing, Quality of Service, QoS, profile provisioning, supervision of the at least one communication terminal, handover decisions for the at least one communication terminal, behavioral information of the at least one communication terminal, determining a relevance of the at least one communication terminal, and determining network upgrade requirements.

In Example 27, the subject-matter of any one of Examples 22 to 26 can optionally include that the radio communication network is a Cellular Wide Area radio communication network configured in accordance with a 3GPP standard.

In Example 28, the subject-matter of any one of Examples 22 to 26 can optionally include that the radio communication network is a Short Range radio communication network.

Example 29 is a device for operating a radio communication network. The device may include means for receiving radio communication network operational data from at least one communication terminal in accordance with a communication device management protocol, and means for determining communication network operation parameters based on the received radio communication network operational data to control the operation of the communication network.

In Example 30, the subject-matter of Example 29 can optionally include that the device includes means to store the radio communication network operational data.

In Example 31, the subject-matter of any one of Examples 29 or 30 can optionally include that the communication device management protocol is a Lightweight Machine-to-Machine, LwM2M, protocol including at least one LwM2M object.

In Example 32, the subject-matter of Example 31 can optionally include that the communication network operational data received from the at least one communication terminal in accordance with the LwM2M protocol includes at least one of the following LwM2M objects: Connectivity Monitoring, Connectivity Statistics, 5GNR Connectivity, Device, Location, Cellular Connectivity and LwM2M Bearer Selection; and that the received radio communication network operational data includes at least one LwM2M object.

In Example 33, the subject-matter of Example 32 can optionally include that each received LwM2M object includes at least one parameter, wherein
the Connectivity Monitoring object parameters include any of: Network Bearer, Available Network Bearer, Radio Signal Strength, Link Quality, IP Addresses, Router IP Addresses, Link Utilization, APN, Cell ID, SMNC and SMCC;
the Connectivity Statistics object parameters include any of: SMS Tx Counter, SMS Rx Counter, Tx Data, Rx Data, Max Message Size, Average Message Size, Collection Period and Start & Stop;
the Device object parameters include any of: Manufacturer, Model Number, Serial Number, Firmware Version, Factory Reset, Available Power Source, Current Time, Hardware Version and Battery Status;
the Location object parameters include any of: Latitude, Longitude, Altitude, Radius, Velocity, Timestamp and Speed;
the Cellular Connectivity object parameters include any of: MSC address, disable radio period, Module activation code, Vendor specific extensions, PSM Timer, Active Timer, Serving PLMN Rate control, eDRX parameters for NB-S1 mode and Activated Profile Names; and
the LwM2M Bearer Selection object parameters include any of: Preferred Communications Bearer, Acceptable RSRP and List of available PLMNs.

In Example 34, the subject-matter of any one of Examples 29 to 33 can optionally include that controlling the operation of the communication network includes at least one of: determining overloaded and/or under-utilized communication networks, traffic routing, Quality of Service, QoS, profile provisioning, supervision of the at least one communication terminal, handover decisions for the at least one communication terminal, behavioral information of the at least one communication terminal, determining a relevance of the at least one communication terminal, and determining network upgrade requirements.

In Example 35, the subject-matter of any one of Examples 29 to 34 can optionally include that the radio communication network is a Cellular Wide Area radio communication network configured in accordance with a 3GPP standard.

In Example 36, the subject-matter of any one of Examples 29 to 34 can optionally include that the radio communication network is a Short Range radio communication network.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A device for operating a radio communication network, the device comprising:
a processor configured to:
receive radio communication network operational data from at least one communication terminal in accordance with a communication device management protocol; and
determine communication network operation parameters based on the received radio communication network operational data to control the operation of the communication network; and
a memory to store the radio communication network operational data.

2. The device of claim 1, wherein the communication device management protocol is a Lightweight Machine-to-Machine, LwM2M, protocol comprising at least one LwM2M object.

3. The device of claim 2, wherein communication network operational data received from the at least one communication terminal in accordance with the LwM2M protocol comprises at least one of the following LwM2M objects:
Connectivity Monitoring, Connectivity Statistics, 5GNR Connectivity, Device,
Location, Cellular Connectivity and LwM2M Bearer Selection,
and wherein the received radio communication network operational data comprises at least one LwM2M object.

4. The device of claim 3, wherein each received LwM2M object comprises at least one parameter, wherein the
Connectivity Monitoring object parameters comprise any of: Network Bearer, Available Network Bearer, Radio Signal Strength, Link Quality, IP Addresses, Router IP Addresses, Link utilization, APN, Cell ID, SMNC and SMCC;
Connectivity Statistics object parameters comprise any of: SMS Tx Counter, SMS Rx Counter, Tx Data, Rx Data, Max Message Size, Average Message Size, Collection Period and Start & Stop;
Device object parameters comprise any of: Manufacturer, Model Number, Serial Number, Firmware Version, Factory Reset, Available Power Source, Current Time, Hardware Version and Battery Status;
Location object parameters comprise any of: Latitude, Longitude, Altitude, Radius, Velocity, Timestamp and Speed;
Cellular Connectivity object parameters comprise any of: MSC address, disable radio period, Module activation code, Vendor specific extensions, PSM Timer, Active Timer, Serving PLMN Rate control, eDRX parameters for NB-S1 mode and Activated Profile Names; and the
LwM2M Bearer Selection object parameters comprise any of: Preferred Communications Bearer, Acceptable RSRP and List of available PLMNs.

5. The device of claim 1, wherein controlling the operation of the communication network comprises at least one of:
determining overloaded and/or under-utilized communication networks,
traffic routing,
Quality of Service, QoS, profile provisioning,
supervision of the at least one communication terminal,
handover decisions for the at least one communication terminal,
behavioral information of the at least one communication terminal,
determining a relevance of the at least one communication terminal, and
determining network upgrade requirements.

6. The device of claim 1, wherein the radio communication network is a Cellular Wide Area radio communication network configured in accordance with a 3GPP standard.

7. The device of claim 1, wherein the radio communication network is a Short Range radio communication network.

8. A terminal communication device, comprising a processor configured to:
determine radio communication network operational data for one or more radio communication connections with a radio communication network; and
send the determined radio communication network operational data to the radio communication network in accordance with a communication device management protocol to thereby enable the radio communication network to control the operation of the communication network.

9. The terminal communication device of claim 8, wherein the terminal communication device is an Internet of Things, IoT, terminal and/or wherein the terminal communication device is a mobile internet of things, mIoT, terminal.

10. The terminal communication device of claim 8, wherein the communication device management protocol is a Lightweight Machine-to-Machine, LwM2M, protocol comprising at least one LwM2M object.

11. The terminal communication device of claim 10, wherein the LwM2M protocol comprises at least one of the following LwM2M objects:
Connectivity Monitoring, Connectivity Statistics, 5GNR Connectivity, Device,
Location, Cellular Connectivity and LwM2M Bearer Selection,
and wherein the received radio communication network operational data comprises at least one LwM2M object.

12. The terminal communication device of claim 11, wherein each LwM2M object comprises at least one parameter, wherein the
Connectivity Monitoring object parameters comprise any of: Network Bearer, Available Network Bearer, Radio Signal Strength, Link Quality, IP Addresses, Router IP Addresses, Link Utilization, APN, Cell ID, SMNC and SMCC;
Connectivity Statistics object parameters comprise any of: SMS Tx Counter, SMS Rx Counter, Tx Data, Rx Data, Max Message Size, Average Message Size, Collection Period and Start & Stop;
Device object parameters comprise any of: Manufacturer, Model Number, Serial Number, Firmware Version, Factory Reset, Available Power Source, Current Time, Hardware Version and Battery Status;
Location object parameters comprise any of: Latitude, Longitude, Altitude, Radius, Velocity, Timestamp and Speed;
Cellular Connectivity object parameters comprise any of: MSC address, disable radio period, Module activation code, Vendor specific extensions, PSM Timer, Active Timer, Serving PLMN Rate control, eDRX parameters for NB-S1 mode and Activated Profile Names; and the
LwM2M Bearer Selection object parameters comprise any of: Preferred Communications Bearer, Acceptable RSRP and List of available PLMNs.

13. The terminal communication device of claim 8, wherein controlling the operation of the communication network comprises at least one of:
determining overloaded and/or under-utilized communication networks,
traffic routing,
Quality of Service, QoS, profile provisioning,
supervision of the at least one communication terminal,
handover decisions for the at least one communication terminal,
behavioral information of the at least one communication terminal,
determining a relevance of the at least one communication terminal, and
determining network upgrade requirements.

14. A method for operating a radio communication network comprising:
receiving radio communication network operational data from at least one communication terminal in accordance with a communication device management protocol; and
determining communication network operation parameters to control the operation of the communication network based on the received radio communication network operational data.

15. The method of claim 14, wherein the communication device management protocol is a Lightweight Machine-to-Machine, LwM2M, protocol comprising at least one LwM2M object.

16. The method of claim 15, wherein receiving radio communication network operational data from at least one communication terminal in accordance with a LwM2M protocol comprises receiving at least one of the following LwM2M objects:
Connectivity Monitoring, Connectivity Statistics, 5GNR Connectivity, Device,
Location, Cellular Connectivity and LwM2M Bearer Selection,
and wherein the receiving radio communication network operational data comprises receiving at least one LwM2M object.

17. The method of claim 16, wherein each LwM2M object comprises at least one parameter, wherein the
Connectivity Monitoring object parameters comprise any of: Network Bearer, Available Network Bearer, Radio Signal Strength, Link Quality, IP Addresses, Router IP Addresses, Link Utilization, APN, Cell ID, SMNC and SMCC;
Connectivity Statistics object parameters comprise any of: SMS Tx Counter, SMS Rx Counter, Tx Data, Rx Data, Max Message Size, Average Message Size, Collection Period and Start & Stop;
Device object parameters comprise any of: Manufacturer, Model Number, Serial Number, Firmware Version, Factory Reset, Available Power Source, Current Time, Hardware Version and Battery Status;
Location object parameters comprise any of: Latitude, Longitude, Altitude, Radius, Velocity, Timestamp and Speed;
Cellular Connectivity object parameters comprise any of: MSC address, disable radio period, Module activation code, Vendor specific extensions, PSM Timer, Active Timer, Serving PLMN Rate control, eDRX parameters for NB-S1 mode and Activated Profile Names; and the
LwM2M Bearer Selection object parameters comprise any of: Preferred Communications Bearer, Acceptable RSRP and List of available PLMNs.

18. The method of claim 14, wherein controlling the operation of the communication network based on the received radio communication network operational data comprises at least one of:
determining overloaded and/or under-utilized communication networks,
routing traffic,
determining Quality of Service, QoS, profile provisioning,
supervising the at least one communication terminal,
determining handovers for the at least one communication terminal,
determining behavioral information of the at least one communication terminal,
determining a relevance of the at least one communication terminal, and
determining network upgrade requirements.

19. A non-transitory computer readable medium comprising instructions which, when executed, implements a method for operating a radio communication network, the method comprising:
receiving radio communication network operational data from at least one communication terminal in accordance with a communication device management protocol; and
determining communication network operation parameters to control the operation of the communication network based on the received radio communication network operational data.

20. A device for operating a radio communication network, the device comprising:
means for receiving radio communication network operational data from at least one communication terminal in accordance with a communication device management protocol; and
means for determining communication network operation parameters based on the received radio communication network operational data to control the operation of the communication network.
